(19) United States
(12) Patent Application Publication
(10) Pub. No.: US 2010/0237603 A1
(43) Pub. Date: Sep. 23, 2010

(54) INDICIA MEANS

(75) Inventors: Richard Waning, Wigton (GB); Chris Hooley, Wigton (GB); Celine Denecker, Wigton (GB)

Correspondence Address: KNOBBE MARTENS OLSON & BEAR LLP, 2040 MAIN STREET, FOURTEENTH FLOOR, IRVINE, CA, 92614, US

(73) Assignee: INNOVIA FILMS LIMITED, WOGTON, CUMBRIA (GB)

(21) Appl. No.: 12/670,374

(22) PCT Filed: Jul. 18, 2008
(86) PCT No.: PCT/GB08/50595

§ 371 Date: May 20, 2010

(30) Foreign Application Priority Data
Jul. 24, 2007 (GB) 0714419.9

(51) Int. Cl. B42D 15/00; B44F 1/12; B42D 15/10

(52) U.S. Cl. 283/67; 428/29

(57) ABSTRACT

UV responsive indicia means comprising a substrate bearing indicia at least partly provided by one or more UV-sensitive materials, the indicia-bearing substrate being protected from exposure to UV radiation by a removable wrapper or peelable covering comprising a polymeric film which is relatively more transmissive with respect to visible light radiation than it is with respect to UV radiation, such that the indicia-bearing substrate is viewable through the removable wrapper or peelable covering and that a visible change in the indicia is effected upon removal of the wrapper or peeling away of the coating.

The present invention concerns indicia means, in particular the use of UV barrier films such as polymeric films which are substantially transparent to visible light but which have UV barrier or blocking properties in a novel application concerning the presentation of information carried by a substrate covered by the films.

The use of barrier materials covering information carried by a substrate beneath the barrier material is well known in the prior art, in particular in connection with security documents and methods in connection therewith using invisible coded markings. Thus, WO-A-98/22291 discloses a security document in which an invisible indicia or encoded information is imprinted on a substrate using a compound which produces a fluorescence at a wavelength greater than about 650 nm when exposed to near infrared radiation, the information being covered by a layer of material that reflects or absorbs a substantial amount of the visible and UV radiation illuminating its surface.

U.S. Pat. No. 4,927,180 discloses a method of marking an article or substrate with a mark or device which is made visible or is enhanced on exposure to UV light which comprises printing onto the article or substrate a photochromic ink, and applying a superficial protective layer to said mark or device which protects the photochromic compound against degradation by atmospheric moisture and oxygen. The superficial protective layer may be a clear film according to this disclosure, but one which transmits UV light in order that the photochromic ink can be viewed through the protective layer when activated by a UV beam.

WO-A-90/06539 discloses a security mark having a photochromic compound covered by a controlled absorption layer comprising a saturable absorber. Light of a wavelength serving to convert the photochromic compound is at low intensity absorbed by the saturable absorber, and a photochromic compound converted by UV is said thus to be sunlight protected. At high intensities, the absorption of the saturable absorber drops to permit conversion of the photochromic compound under the influence of the high intensity UV.

GB-A-2243578 discloses a security label comprising a backing layer, a design layer and an upper removable layer. When the upper layer is peeled back to expose the design layer, so as to expose the design layer to an actuating influence such as ultraviolet light, the design layer changes colour. This is said to indicate that the article to which the label has been applied is genuine. The design layer may be a photochromic ink or other verifiable substance such as a UV reactive ink, fluorescent ink, magnetic ink, IR ink, transfer-type ink, optical variable device, hologram or rare earth mineral. The removable layer may be peeled or scratched off.

U.S. Pat. No. 5,807,625 discloses a security document comprising a substrate having an ink pattern on a surface thereof, said ink comprising binder and particles of at least one photo dye stuff consisting of a solid solution or dispersion of photochromic compound and polymeric protecting composition, wherein said polymeric protecting composition is a light-transparent thermoplastic which is inert to the photochromic compound and which is further a barrier for oxygen.

According to the present invention there is provided UV responsive indicia means comprising a substrate bearing indicia at least partly provided by one or more UV-sensitive materials, the indicia-bearing substrate being protected from exposure to UV radiation by a removable wrapper or peelable covering comprising a polymeric film which is relatively more transmissive with respect to visible light radiation than it is with respect to UV radiation, such that the indicia-bearing substrate is viewable through the removable wrapper or peelable covering and that a visible change in the indicia is effected upon removal of the wrapper or peeling away of the covering.

The substrate may comprise a security document such as a banknote, credit card, cheque, travellers cheque, passport, driving licence or other identity document. However, it may also comprise an article of commerce or the, or part of the, packaging therefor. For example, the manufacturer of a cigarette packet or a CD or DVD, just by way of example, may elect to use the carton, case or box as the indicia-bearing substrate, and the carton, case or box may then be overwrapped with the removable wrapper. Because the removable wrapper is relatively more transmissive with respect to visible light radiation than it is with respect to UV radiation, the effect is that the contents of the removable wrapper can be viewed (for example by the prospective purchaser), but on removing the wrapper the said contents undergo a visible change in appearance as a result of the effect of UV radiation on the at least one indicia UV-sensitive material. This feature may have security implications, for example to determine whether a product has been tampered with or previously opened, but it may also have an aesthetic or marketing appeal, for example to effect display of a logo or message to the consumer, or it may have a regulatory connotation in connection with the display of warning notices or concerning health, or anti-counterfeiting for example.

The indicia may be provided in the form of, for example, a logo, picture, brand name, security or identification feature, message, hologram, or any other type of visual information. The UV sensitivity of the indicia may mean that the indicia is completing invisible when covered by the removable wrapper or peelable covering, and only becomes visible on exposure to UV light brought about by removing the wrapper or covering. Alternatively, the indicia may be provided in a form which has a first appearance before exposure to UV light, and a second different appearance after exposure to UV light. For example, the indicia may undergo a colour change upon exposure to UV light. The indicia may also be provided in a form which is part UV-sensitive and part insensitive. Thus for example, an image formed from two components—a first UV-sensitive component and a second non UV-sensitive component may have a first appearance when covered by the removable wrapper or peelable covering, and may change appearance upon removal of the wrapper or peeling of the covering, and exposure of the UV-sensitive part of the indicia to UV light.

By “removable wrapper” is preferably meant a film wrapper which is at some point in the commercial life of the indicia-bearing substrate intended to be removed, and is designed to be removed, for example by the provision of peelable or tearable seals, or by the provision of a tear tape or line of weakness as is well known in the packaging art. By “peelable covering” is preferably meant a film covering which is specifically intended to be removed from the indicia-bearing substrate at some point during its commercial life. The film covering may form a peel seal with the substrate (in other words it may be sealed directly to the substrate, usually by means of a heat seal) or it may be provided with a peelable adhesive layer effective to adhere the film covering to the substrate. Naturally in this case it is desirable that the adhesive layer be substantially transparent at least to visible light.

The removable wrapper or peelable covering, once removed or peeled, may in some circumstances be replaced. In that case, the indicia may undergo a further change, or revert back to its original appearance, or it may remain unchanged in its UV-sensitised form, depending on the nature of the UV-sensitive material(s).

The UV-sensitive material may be selected from, for example, photochromic materials, fluorescent materials and phosphorescent materials, or mixtures of two or more thereof. By “UV-sensitive” is preferably meant that the indicia indicated by the material(s) provides an image (which may or may not be invisible to the naked eye) which alters its appearance, or becomes visible, or becomes invisible, when exposed to UV radiation, in particular radiation of wavelength from about 190 to about 400 nm. Preferably the indicia undergoes no change of appearance on exposure to light in the visible region of the spectrum (eg, from about 400 to about 700 nm) when unaccompanied by UV radiation.

Photochromic materials, such as photochromic dyes and printing inks made therefrom, are well known in the art and may comprise for example spiroindolino-naphthoxazines, fulgides and fulgimides and/or spiro(18a)-dihydroindolizines. Such printing inks may be printed onto the substrate by any one of a number of known printing methods, including gravure, reverse gravure, heliogravure, flexographic, plate, intaglio, letterpress, dry offset, indirect letterpress, lithographic, wet offset or screen printing.

Fluorescent materials are also well known and may comprise for example inorganic materials, in particular doped rare earth compounds such as yttrium oxysulphide doped with europium, barium magnesium aluminate doped with europium and barium magnesium aluminate doped with europium and manganese, available under the trade name UVEDA from Nemoto & Co., Ltd, 1-15-1, Kamiogi, Suginami-ku, Tokyo 167, Japan, specifically as YS-A4/Red, ALN-BP4/Blue and ALN-GP4/Green respectively. Other fluorescers include organic materials such as stilbenes, coumarins, thioxanthones, rhodamines, benzoxazoles, azo dyes, polycyclic aromatic hydrocarbons and heterocycles including Lumogen™ dyes and pigments (BASF; Mt. Olive, N.J.), thioxazoles, decacyclene, fluoroscein, fluorene, 9-fluorenone, fluoranthene, and the like. Preferred among the foregoing are thioxazoles and polycyclic aromatics. Such materials can be in the form of solubilised or dispersed powders, dissolved liquids, dispersed microspherical particles, and the like. Other suitable materials include those organic rare earth complexes available under the trade name Lumilux from Honeywell Specialty Chemicals Seelze Gmbh, Postfach 10 02 62 D-30918 Seelze, Germany. Particular examples include Lumilux Red E9498, Lumilux Green CD 302, Lumilux Green CD 333, Lumilux Green CD 321 and Lumilux Yellow-Green CD 342.

Examples of suitable phosphorescent materials include zinc sulphides and radioisotopic compounds, and doped metal oxides such as the strontium oxide based compounds such as the strontium oxide aluminates available under the trade name LumiNova™ from Nemoto & Co., Ltd. of Tokyo, Japan.

The UV sensitive material may also or instead comprise another class of optically sensitive compounds, for example the luminescent aromatic heterocycles available under the trade designations L-88 and L-187 from Beaver Luminescers. Provided the UV sensitive material shows a visible change in appearance on exposure to UV light the it may be considered suitable for use in the indicia means of the invention.

The polymeric film used for forming the removable wrapper or peelable covering may be a plastic or cellulosic film formed from, for example, polyolefin, polyester, cellulose, PLA, and many others. One particularly preferred polyolefinic film is polypropylene, in particular biaxially oriented polypropylene.

The polymeric film is more transmissive with respect to visible light than it is with respect to UV radiation. Preferably, the average transmittance of the film of radiation between 400 and 700 nm is at least about 5%, more preferably at least about 10%, still more preferably at least about 15%, yet more preferably at least about 20%, and most preferably at least about 25% more than the average transmittance of the film of radiation between the wavelengths 200 and 400 nm. Preferably, a maximum transmittance of the film in the visible region of the spectrum is at least about 50%, more preferably at least about 60%, still more preferably at least about 70% and most preferably at least about 75% higher than the lowest point of transmittance of the film in the UV region of the spectrum.

Preferably the polymer film is a thermoplastic of biopolymer film, more preferably a polyolefinic film (which may be a homo-, bi-, ter-, or orco-polymer and/or any mixture(s) thereof) and/or cellulosic film or film made from PLA or other starch based derivative. More preferably the film comprises polypropylene, polyethylene, mixtures and/or co-polymer(s) thereof. Most preferably the film is a polypropylene homopolymer. The film may be a multilayer structure formed by any suitable method (such as co-extrusion and/or lamination) with one or more core or surface layers being formed as described herein.

In one embodiment of the invention the film comprises biaxially oriented polypropylene (BOPP). The BOPP films may be prepared with substantially balanced physical properties, for example as can be produced using substantially equal machine direction and transverse direction stretch ratios, or can be unbalanced where the film is significantly more oriented in one direction (MD or TD). Sequential stretching can be used, in which heated rollers effect stretching of the film in the machine direction and a stenter over is thereafter used to effect stretching in the transverse direction, or simultaneous stretching, for example using the so-called bubble process. The machine direction and transverse direction stretch ratios are preferably in the range of from 4:1 to 10:1, and more preferably from 6:1 to 8:1.

In order to ensure that the polymeric film is relatively more transmissive with respect to visible light radiation than it is with respect to UV radiation, the polymeric film may be provided with an additive which absorbs and/or fluoresces in the UV (hereinafter referred to as a UV absorber or UV additive). Suitable UV absorbers include both organic and inorganic materials. Amongst suitable organic UV absorbers may be mentioned polar organic UV absorbers such as: benzotriazoles, of which 2-(2′-hydroxy-3′,5′-di-t-amylphenyl)benzotriazole available under the trade name Cyasorb UV-2337 from Cytec Industries Inc. and under the trade name Lowilite 28 from Great Lakes Chemical Corporation and phenol, 2-(5-chloro-2H-benzotriazole-2-yl)-6-(1,1-dimethylethyl)-4-methyl-available under the trade name Tinuvin 326 from Ciba Specialty Chemicals Inc. may be mentioned as examples; benzophenones of which methanone, 2-hydroxy-4-(octyloxy)-phenyl available under the trade name Chimassorb 81 from Ciba Specialty Chemicals Inc. and triazines of which 2-[4,6-bis(2,4-dimethylphenyl)-1,3,5-triazin-2-yl]-5-(octyloxy)phenol available under the trade name Cyasorb UV-1164 from Cytec Industries Inc. may be mentioned as examples, and compositions comprising mixtures thereof, of which Shelfplus UV 1400 available from Ciba Specialty Chemicals Inc. may be mentioned as an example. Other types of organic UV absorber, such as poly[2-(4-benzoyl-3-hydroxyphenoxy)ethyl acrylate available commercially from Sigma-Aldrich (product number 41,323-2) will be known to persons skilled in the art.

Amongst inorganic UV absorbers may be mentioned micronised metal oxides such as zinc and titanium oxides, and mixtures thereof. Suitable zinc oxide UV additives are commercially available under the trade name Bayoxide from Borchers GmbH.

The UV additive may comprise a mixture of organic UV additives, and/or a mixture of inorganic UV additives, and/or a mixture of organic and inorganic UV additives.

The film core or the skin layers of the film may comprise additional materials such as anti-block additives, opacifiers, fillers, cross-linkers, colourants, waxes and the like.

The film may be further treated, by coroner discharge treating for example, to improve ink receptivity of the film or of the skin layer of the film.

The films used in accordance with the present invention can be of a variety of thicknesses according to the application requirements. For example they can be from about 10 to about 240 microns thick, and preferably from about 20 to about 60 microns thick.

In the case where the film is a multilayer film having one or more skin layers, the skin layers preferably have a thickness of from about 0.05 microns to about 2 microns, preferably from about 0.1 microns to about 1.5 microns, more preferably from about 0.2 microns to about 1.25 microns, most preferably from about 0.3 microns to about 0.9 microns.

The indicia-bearing substrate may comprise a substrate material with the at least one UV sensitive material printed, coated, coextruded or otherwise mounted thereon. Alternatively, or as well, the at least one UV sensitive material may be incorporated in the body of the substrate. There are many examples that could be mentioned, one such being where the substrate itself is a polymeric film and the at least one UV sensitive material is incorporated in therein, for example by extrusion or coextrusion with the filmic material.

Also provided in accordance with the present invention is a method of providing changeable indicia on an article, the method comprising the steps of marking the article with indicia formed from at least one UV-sensitive material and covering at least the marked region of the article with a film covering formed from a polymeric film which is relatively more transmissive with respect to visible light radiation than it is with respect to UV radiation so that the marked region of the article can be viewed with the naked eye through the film covering and so that the marked region of the article changes its appearance to the naked eye when the film covering is removed and the marked region of the article is consequently exposed to an increased amount of incident UV radiation.

Also provided in accordance with the invention is a useful article bearing indicia formed from at least one UV-sensitive material, the indicia displaying to the naked eye a first appearance when viewed through a film covering provided over the indicia and a second changed appearance when the film covering is removed, the film covering being formed from a polymeric film which is substantially transparent to visible light but at least less transparent with respect to UV light.

The indicia means of the invention is also capable of similar application with IR sensitive materials. Thus, according to the present invention there is provided IR responsive indicia means comprising a substrate bearing indicia at least partly provided by one or more IR-sensitive materials, the indicia-bearing substrate being protected from exposure to IR radiation by a removable wrapper or peelable covering comprising a polymeric film which is relatively more transmissive with respect to visible light radiation than it is with respect to IR radiation, such that the indicia-bearing substrate is viewable through the removable wrapper or peelable covering and that a visible change in the indicia is effected upon removal of the wrapper or peeling away of the covering.

The indicia means of the invention is also capable of similar application with materials which are sensitive to light of a particular wavelength. Thus, according to the present invention there is provided first wavelength light responsive indicia means comprising a substrate bearing indicia at least partly provided by one or more first wavelength light-sensitive materials, the indicia-bearing substrate being protected from exposure to first wavelength light radiation by a removable wrapper or peelable covering comprising a polymeric film which is relatively more transmissive with respect to visible second wavelength light radiation than it is with respect to first wavelength light radiation, such that the indicia-bearing substrate is viewable through the removable wrapper or peelable covering and that a visible change in the indicia is effected upon removal of the wrapper or peeling away of the covering.

The invention will now be more particularly described with reference to the following examples.

### EXAMPLES 1 to 4

A three layer polymeric tube was formed by co-extruding a core layer of polypropylene homopolymer with two skin layers of polyethylene/polypropylene/polybutylene terpolymer (a random copolymer) on opposite sides of the core layer. A UV additive composition Shelfplus UV1400, which is a blend of benzophenone, zinc oxide and benzotriazole UV absorbers available from Ciba Specialty Chemicals, was added prior to extrusion to the material of the core layer by way of a masterbatch containing polypropylene homo polymer and 10% by weight Shelfplus. The tube was cooled and subsequently reheated before being blown to produce a three layer biaxially oriented film tube. The blown film tube was laminated to itself to provide a five layer film of 58 μm thickness. The optical and UV transmittance properties of the films were measured and the results shown in Table 1:

TABLE 1

| | | Wide | | | |
|---|---|---|---|---|---|
| | Shelfplus | Angle | Gloss at | % T at | % T at |
| Example | Level (% wt) | Haze (%) | 45° (%) | 365 nm | 254 nm |
| 1 | 0 | 1.9 | 94.7 | 89.44 | 83.23 |
| (comparative) | | | | | |
| 2 | 0.2 | 2.5 | 93.2 | 54.19 | 51.28 |
| 3 | 0.3 | 2.9 | 89.9 | 40.5 | 37.82 |
| 4 | 0.5 | 3.9 | 91.8 | 24.79 | 23.42 |

The wide angle haze measurements, although they increase with added Shelfplus, are still within acceptable levels for each of Examples 2 to 4, as are the gloss measurements. The UV absorptive effect of the additive is clearly demonstrated.

### EXAMPLE 5

Using a Red k-bar, a photochromic ink was drawn down onto a voided polypropylene film of thickness 85 μm with a matt print receptive coating, yield 16.7 m2/kg, to provide an approximate coat weight of 2.4 μm.

The draw down was repeated, this time on the same film which had been previously printed with yellow ink (Astrathane MF mid yellow from Flint-Schmidt) using an RK proofing gravure printer.

These samples were tested using an ultraviolet light, with and without film coverings from Examples 2 to 4. In the absence of the covering film the photochromic pigment was activated, and changed colour accordingly. With the covering film in place the pigment was not activated to the same extent and was much less coloured. These results were replicated when the same samples were placed in sunlight.

### EXAMPLES 6 to 18

A number of polypropylene film samples with different UV sensitive materials therein were prepared on a lab scale. The substrate material was twice extruded through a Prism extruder with the torque set at approximately 50% and a temperature gradient of from 210° C. at the hopper to 230° C. at the die, and plaques hot pressed from the extrudate at 230° C. and 20 ton pressure. The plaques were stretched on a Bruchner stretcher at 130° C. at 3 m/min with a residence time of 10 mins and a heater setting of 0.6 mA. The samples were drawn to 950 mm² and A4 size sheets of the drawn samples were then cut out, and found to be of 21-22 μm thickness. The optical and UV transmittance properties of the films were measured and the results shown in Table 4:

TABLE 4

| | | Concentration | Haze^{c} | Clarity^{c} |
|---|---|---|---|---|
| Example | UV Sensitive Material | (%) | (%) | (%) |
| 16 | Lumilux Green CD 302^{a} | 1 | 25.5 | 85.6 |
| 7 | Lumilux Green CD 302^{a} | 0.5 | 9.36 | 92.1 |
| 8 | Lumilux Green CD 302^{a} | 0.25 | 0.72 | 95.3 |
| 9 | Lumilux Green CD 302^{a} | 0.1 | 0.40 | 95.7 |
| 10 | Lumilux Yellow-Green CD | 1 | 1.72 | 94.5 |
| | 342^{a} | | | |
| 11 | Lumilux Yellow-Green CD | 0.5 | 0.56 | 95.8 |
| | 342^{a} | | | |
| 12 | Lumilux Yellow-Green CD | 0.25 | 0.76 | 95.2 |
| | 342^{a} | | | |
| 13 | Lumilux Yellow-Green CD | 0.1 | 0.67 | 96.8 |
| | 342^{a} | | | |
| 14 | Beaver Luminescent | 1 | 29.3 | 91.8 |
| | Pigment L-88^{b} | | | |
| 15 | Beaver Luminescent | 0.5 | 8.41 | 93.6 |
| | Pigment L-88^{b} | | | |
| 16 | Beaver Luminescent | 0.25 | 2.64 | 95.6 |
| | Pigment L-88^{b} | | | |
| 17 | Beaver Luminescent | 0.1 | 0.58 | 97.2 |
| | Pigment L-88^{b} | | | |
| 18 | Beaver Luminescent | 1 | 31.5 | 86.6 |
| | Pigment L-187^{b} | | | |

^{a}from Honeywell Specialty Chemicals Seelze Gmbh, Postfach 10 02 62 D-30918 Seelze, Germany.
^{b}from Beaver Luminescers.
^{c}haze and clarity were measured with the Hazeguard ™.

These films were found to exhibit intense colour when exposed to UV light of a particular wavelength. The films were used to wrap white cigarette packets.

### EXAMPLES 19 to 23

A number of polypropylene film samples with different UV absorbers materials therein at a concentration of 1% by weight were prepared on a lab scale. The substrate material was twice extruded through a Prism extruder with the torque set at approximately 50% and a temperature gradient of from 210° C. at the hopper to 230° C. at the die, and plaques hot pressed from the extrudate at 230° C. and 20 ton pressure. The plaques were stretched on a Bruchner stretcher at 130° C. at 3 m/min with a residence time of 10 mins and a heater setting of 0.6 mA. The samples were drawn to 950 mm² and A4 size sheets of the drawn samples were then cut out, and found to be of 21-22 μm thickness. The optical and UV transmittance properties of the films were measured and the results shown in Table 5:

TABLE 5

| | | Haze | Clarity |
|---|---|---|---|
| Example | UV Absorber | (%) | (%) |
| 19 | poly[2-(4-benzoyl-3-hydroxyphenoxy)ethyl | 1.14 | 96.5 |
| | acrylate^{a} | | |
| 20 | Lowilite^{b} | 0.55 | 97.6 |
| 21 | Chimassorb^{c} | 0.91 | 95.3 |
| 22 | Bayoxide Z Transparent^{d} | 8.41 | 91.1 |
| 23 | Bayoxide Z Aktiv^{d} | 6.87 | 95.7 |

^{a}from Sigma-Aldrich (product number 41,323-2).
^{b}2-(2′-hydroxy-3′,5′-di-t-amylphenyl) benzotriazole available under the trade name from Great Lakes Chemical Corporation.
^{c}methanone, 2-hydroxy-4-(octyloxy)-phenyl from Ciba Specialty Chemicals Inc.
^{d}from Borchers GmbH

The films of Examples 19 and 21 were cut into strips and laid over the wrapped cigarette packets prepared in accordance with Examples 11 to 23. When UV light was then shone on the packets it was found that the colour intensity of the pigmented film was much greater in the region of the pack not overlaid by the UV absorbing strip. However, the pack was still clearly visible through the overlaid strip region. When the strip was removed, the colour intensity of the region uncovered by the strip increased to be at the same level as the surrounding pack not previously covered.

1. An ultraviolet (UV) responsive indicia comprising:
a substrate bearing an indicia comprising one or more UV-sensitive materials; and
a peelable covering comprising an attached configuration and a peeled configuration;
wherein the attached configuration comprises the indicia being protected from exposure to UV radiation by the peelable covering comprising a polymeric film which is relatively more transmissive with respect to visible light radiation than it is with respect to UV radiation, such that the indicia is viewable through the peelable covering,
wherein the peeled configuration comprises a visible change in the indicia effected upon peeling away of the peelable covering from the indicia.

2. The UV responsive indicia according to claim 1 wherein the UV-sensitive material is selected from the group consisting of: photochromic materials, fluorescent materials, phosphorescent materials, luminescent materials, light splitting materials and mixtures of two or more thereof.

3. The UV responsive indicia according to claim 1 wherein the polymeric film used for forming the peelable covering is a thermoplastic or biopolymeric film.

4. The UV responsive indicia according to claim 1 wherein the polymeric film is selected from the group consisting of: polyolefin, polyester, cellulose and PLA.

5. The UV responsive indicia according to claim 1 wherein the average transmittance of the polymeric film of radiation between 400 and 700 nm is at least about 5% more than the average transmittance of the film of radiation between the wavelengths 190 and 400 nm.

6. The UV responsive indicia according to claim 1 wherein a maximum transmittance of the film in the visible region of a spectrum is at least about 50% higher than the lowest point of transmittance of the film in the UV region of the spectrum.

7. The UV responsive indicia according to claim 1 wherein the polymeric film is provided with an additive which absorbs and/or fluoresces in UV radiation.

8. The UV responsive indicia according to claim 7 wherein the additive is selected from the group consisting of: benzotriazoles, benzotriazines, benzophenones and mixtures of two or more thereof.

9. The UV responsive indicia according to claim 7 wherein the additive is selected from the group consisting of: micronised metal oxides and mixtures of two or more thereof.

10. A method of providing changeable indicia on an article, the method comprising:
marking the article with an indicia formed from at least one UV-sensitive material; and
covering at least the indicia with a film covering formed from a polymeric film that is relatively more transmissive with respect to visible light radiation than it is with respect to UV radiation,
wherein the indicia can be viewed with the eye through the film covering,
wherein the indicia changes its appearance from a first appearance to a second appearance to the eye when the film covering is removed from the indicia and the indicia is consequently exposed to an increased amount of incident UV radiation.

11. (canceled)

12. The method of claim 10, further comprising removing the film covering from the indicia.

13. The method of claim 12, further comprising replacing the film covering on the indicia after the removing step.

14. The method of claim 10, further comprising coupling said UV-sensitive indicia to one of the group consisting of: a security document, an identity document, an article of commerce and packaging.

15. The method of claim 10, wherein the indicia is one of the group consisting of a logo, a picture, a brand name, a security feature, an identification feature, a message and a hologram.

16. An ultraviolet (UV) responsive indicia means comprising:
a substrate bearing an indicia comprising one or more UV-sensitive materials; and
a removable wrapper comprising an attached configuration and a removed configuration;
wherein the removable wrapper comprises a polymeric film that is relatively more transmissive with respect to visible light radiation than it is with respect to UV radiation,
wherein the attached configuration comprises the indicia being protected from exposure to UV radiation by the removable wrapper while the indicia is viewable through the removable wrapper,
wherein the removed configuration comprises a visible change in the indicia upon removal of the removable wrapper from the indicia.

17. The UV responsive indicia according to claim 16 wherein a maximum transmittance of the film in the visible region of a spectrum is at least about 70% higher than the lowest point of transmittance of the film in the UV region of the spectrum.

18. The UV responsive indicia according to claim 16 wherein the average transmittance of the polymeric film of radiation between 400 and 700 nm is at least about 15% more than the average transmittance of the film of radiation between the wavelengths 200 and 400 nm.
